(19) United States
(12) Patent Application Publication
(10) Pub. No.: US 2012/0061878 A1
(43) Pub. Date: Mar. 15, 2012

(54) Device And Method For Machining The Circumference Of A Materials By Means Of A Laser

(75) Inventors: Otto Hofmann, Weimar (DE); Jens Bliedtner, Jena (DE); Hartmut Mueller, Franz-Gresitze-Strasse (DE); Juergen Bischoff, Jena (DE)

(73) Assignee: Otto Hofmann, Weimar (DE)

(21) Appl. No.: 13/319,594

(22) PCT Filed: May 10, 2010
(86) PCT No.: PCT/DE2010/050026

§ 371 Date: Nov. 10, 2011

(30) Foreign Application Priority Data
May 13, 2009 (DE) 10 2009 021 448.8

(51) Int. Cl. B29C 35/08

(52) U.S. Cl. 264/400; 425/174

(57) ABSTRACT

The invention relates to a method and a device for machining the periphery of a workpiece (8) by means of a laser (1). The device includes a peripheral mirror (5) with a peripheral mirror system axis (9) and an optical system which couples a radiation beam (3) perpendicular to the peripheral mirror system axis (9) into the peripheral mirror (5) such that it hits the workpiece (8) after several reflections, the workpiece axis (11) extending in the same direction within the peripheral mirror (5) than the peripheral mirror system axis (9). According to the method of the invention, the radiation beam (3) is coupled into the peripheral mirror (5) over a predefined machining time, wherein the workpiece (8), the peripheral mirror (5) and/or the optical system are maintained in a relative position of rest or moved in relation to one another.

### RELATED APPLICATIONS

The present application is a U.S. National Stage application of International PCT Application No. PCT/DE2010/050026 filed on May 10, 2010 which claims priority benefit of German Application No. DE 10 2009 021 448.8 filed on May 13, 2009, the contents of each are incorporated by reference in their entirety.

### FIELD OF THE INVENTION

The present invention relates to a system for machining the periphery of a workpiece, especially a strand, rod, tubing or other similar materials (which are referred to herein as “extended workpieces”), by means of a laser, such as is generically known from U.S. Pat. No. 3,865,564. The invention also relates to a generic method in which this system can be used.

### BACKGROUND OF THE INVENTION

The invention can be used to advantage in processes in which viscous fluid streams, e.g., of glass, polymers, organic glass, metal or similar substances, are noncontactingly constricted or are separated into parts.

The invention can also be used to separate and machine solid extended workpieces and semi-finished products to influence, along their periphery, the properties of the materials from which they are made.

It is known that extended workpieces of the aforementioned materials can be mechanically tooled, which may, however, entail drawbacks due to the fact that the properties in the region machined are changed. Thus, e.g., the use of mechanical shears leads to changes in the structure of the material in the region in which the material was cut, e.g., to constrictions in the case of metal materials, or to local cooling of viscous melts or fluids.

Non-contact methods of machining materials reduce, or even completely eliminate, such undesirable changes in the properties of the material. In addition to the application of electric or electromagnetic phenomena, the use of high-energy radiation, such as is emitted by lasers, is another possibility for machining a material that can be used in many areas of application.

Using laser radiation makes it possible to direct the energy of the laser beam extremely accurately onto the regions of the material to be machined. Only in this manner is it possible to achieve the targeted effects, e.g., melting, separating or hardening. In addition, a number of applications require that the laser radiation be applied both uniformly and simultaneously to a defined region of the material so as to avoid undesirable local thermal stresses.

When machining extended workpieces, machining by laser requires special technical and technological considerations. If the material to be machined is separated from the after or as a result of laser radiation, the laser and the optionally required optical elements can be disposed within the same axis in which the extended workpiece is moved (principal axis). If, however, the machined part of the material remains attached to the extended workpiece, such as is the case, e.g., in the production of fibers, the laser, as well as at least some of the associated optical elements, must be moved away from the axis of the extended workpiece. Yet, it must be ensured that the laser beam is applied precisely, uniformly, and simultaneously onto the periphery of the workpiece.

### PRIOR ART

To meet these requirements, a number of prior-art solutions are known.

DE 10 2004 003 696 A1 discloses a ring-shaped configuration of a plurality of lasers in a plane, the optical axes of which in the radial direction are directed perpendicular to the principal axis of the extended workpiece. In the overlapping areas of the divergent laser beams, this leads to the formation of a region with constant energy density which makes it possible to machine the extended workpiece across its periphery.

DE 100 20 327 A1 describes how it is possible, again using a plurality of lasers, to machine a workpiece across its entire periphery. To this end, the beams of the lasers are combined in a ring-shaped focus by means of a ring-shaped optical element. This system is especially useful for machining rotationally symmetric workpieces. The ring-shaped focus can also be produced from only one laser beam by means of beam-forming optical elements.

U.S. Pat. No. 4,044,936 discloses a system by means of which it is possible to machine tubular hollow bodies by means of a laser beam. To this end, the laser beam is point-focused by means of optical elements on the inside or outside surface of the workpiece or material. The periphery can be continuously machined by rotating specific optical elements that are located in the beam path. A configuration of the laser outside the principal axis of the workpiece or material is described in two practical examples. To this end, the laser beam is deflected by at least one mirror and optionally focused by means of additional optical elements. The laser beam continues to be point-focused only.

A technical solution for machining asymmetrical surfaces of workpieces by means of a laser is disclosed in U.S. Pat. No. 4,456,811. Using a segmented mirror, an annular laser beam is divided into individual sub-beams and directed onto the surface of a material or workpiece that is to be machined. This approach again allows a workpiece to be simultaneously machined across a periphery. The objective of this solution is to convert the energy of the laser beam in the area impinged by the laser beam in a defined manner. The principal axis of the laser beam is located in the same axis as the principal axis of the material or workpiece. In addition, the document also discloses that the laser beam emitted by a laser that is disposed so as to be laterally offset is fed into the principal axis of the material or workpiece by means of a pinhole mirror. This, however, may cause the beam impinging on the surface to be machined to become C-shaped. This nonuniform distribution of the radiation energy must be compensated for by rotating the material or workpiece.

U.S. Pat. No. 3,865,564 discloses a system for producing glass fibers by heating the starting material, i.e., an extended glass workpiece. The laser beam emitted by a laser that is located outside the principal axis is formed into an annular beam by means of a rotating, eccentrically disposed lens and directed in the direction of the principal axis of the extended glass workpiece via a pinhole mirror, through the aperture of which the finished glass fiber is passed. Via a conical mirror, the axis of which coincides with the principal axis of the extended glass workpiece and which completely and symmetrically covers the extended glass workpiece to be machined, the laser beams are directed onto the surface of the extended glass workpiece. The extended glass workpiece is heated by the impinging laser beam and can be drawn to form a fiber. Thus, in the region of the conical mirror, the laser beams coming from the laser source and deflected through the pinhole mirror are uniformly distributed across a defined width of the periphery of the extended glass workpiece, and a region with uniform energy distribution is created.

The configuration and function of the individual elements disclosed in U.S. Pat. No. 3,865,564 makes it possible for laser radiation to be uniformly applied to a defined region of a potentially infinitely long billet material or workpiece across the entire periphery of that region. An obstacle to a simple workpiece feed and the machining even of hot workpieces is the pinhole mirror mentioned.

In addition, the entire system is dimensioned for the workpiece to be machined, which [workpiece] in this case is a fiber. In order to machine workpieces having substantially larger diameters, the entire system must be redimensioned.

U.S. Pat. No. 4,012,213 discloses a method of producing fireproof fibers which are drawn from a rod-shaped material. The rod-shaped material is moved at a predetermined speed through a heating zone. To create the heating zone, means for emitting laser radiation as well as optical means for dividing the laser radiation into a plurality of laser beams and for deflecting and focusing these laser beams onto the periphery of the rod-shaped material are provided. The laser radiation does not impinge uniformly on the periphery of the material.

In U.S. Pat. No. 4,058,699, again a heating zone in a heating system is created by means of laser radiation. Within a cylindrical peripheral mirror with an elliptical cross section, a conical reflector is disposed along a first cylinder axis which passes through the first focal point of the elliptical cross section, and a rod-shaped workpiece that is to be heated is disposed along a second cylinder axis which passes through the second focal point of the elliptical cross section. An expanded laser beam, which after multiple reflections from all sides impinges on the periphery of the workpiece, is directed onto the conical reflector. The laser beam is fed parallel to the axis of the workpiece into the heating system, which is the reason that a suitable installation space must be available in the axial direction. In addition, the elliptical cross-sectional shape of the peripheral mirror imposes restrictions on the manner in which the laser beam can be fed into the heating system and on the placement of the workpiece inside the peripheral mirror.

### OBJECTS OF THE INVENTION

The disadvantage of the prior solutions is that they are extremely complex as evidenced, inter alia, by the fact that the simultaneous arrangement of a plurality of lasers or the use of rotating optical elements is required. These measures aim at converting energy at the machining site, on the one hand, and at feeding in a laser beam that is emitted by a laterally disposed laser. Machining asymmetrical workpieces requires complex and expensive control engineering-related adjustments. Another problem that has not yet been solved pertains to the case in which the workpiece to be machined is not disposed in the center of the configuration for laser machining.

Thus, the problem to be solved by the present invention is to make available a compact system that allows the workpiece to be fed in easily and that can be adjusted, requiring only a few changes, to allow the machining of workpieces having different cross sections and different dimensions.

Another problem to be solved by the present invention is to make available an alternative method of machining the periphery of a workpiece by means of a laser, with the possibility of exposing the workpiece to a predetermined energy distribution across the periphery.

### SUMMARY OF THE INVENTION

This problem is solved by a system with the features of claim 1 and by a method with the features of claim 20.

Useful advanced embodiments follow from the dependent claims.

### BRIEF DESCRIPTION OF THE DRAWINGS

The device and the method will be explained in greater detail based on the drawings which illustrate practical examples.

As can be seen:

FIG. 1 shows a diagrammatic sketch of a system according to the present invention,

FIG. 2a shows the path of a bundle of rays in the Y-Z plane up to the first reflection,

FIG. 2b shows the path of a bundle of rays in the X-Y plane up to the first reflection,

FIG. 3a shows the path of a bundle of rays in a peripheral mirror 5 formed by a circular cylindrical mirror when a workpiece with a relatively small workpiece radius is involved,

FIG. 3b shows the path of a bundle of rays in a peripheral mirror 5 formed by a circular cylindrical mirror when a workpiece with a relatively large workpiece radius is involved,

FIG. 4 shows a peripheral mirror 5 formed by a rectangular mirror with a square cross section,

FIG. 5 shows a peripheral mirror 5 formed by a prismatic mirror with a pentagonal cross section and additional mirror elements 14,

FIG. 6 shows a peripheral mirror 5 formed by a prismatic mirror with an octagonal cross section and additional mirror elements 14,

FIG. 7 shows a peripheral mirror 5 with a polygonal mirror as an additional mirror element 14,

FIG. 8 shows a peripheral mirror 5 with a corner mirror as an additional mirror element 14,

FIG. 9 shows a system with an additional optical system and two beam entrance apertures,

FIG. 10 shows a peripheral mirror 5 formed by a mirror having the shape of a truncated circular cone or a mirror having the shape of a truncated pyramid with a round or n-cornered cross-sectional area,

FIG. 11 shows machining of part of the periphery of a workpiece 8,

FIG. 12 shows a model for the path of rays of the bundle of rays 3 inside a peripheral mirror 5, and

FIG. 13 shows a diagram of the energy distribution across the periphery of a workpiece 8.

### DESCRIPTION OF THE EMBODIMENTS

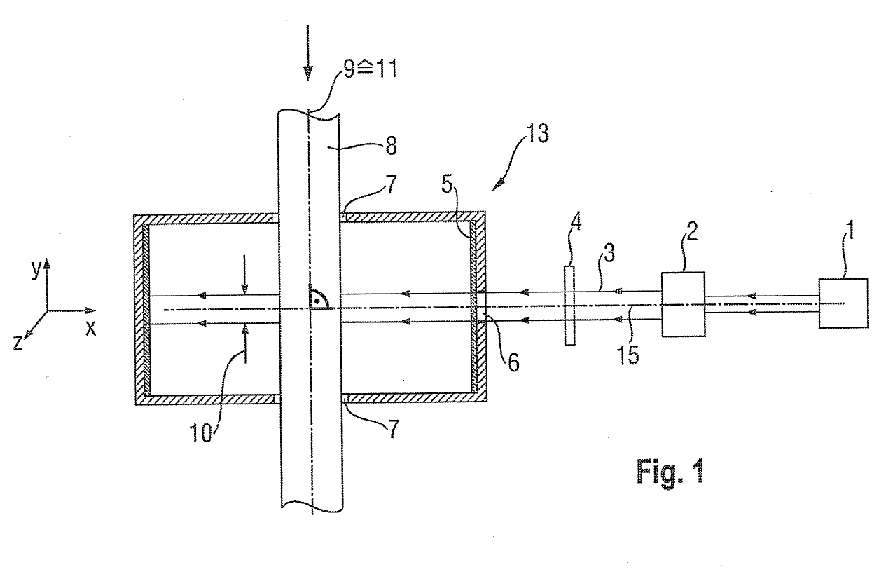

A system according to the present invention, as diagrammatically represented in FIG. 1, comprises a machining chamber 13 and an optical system with an optical axis 15, with the optical system being formed by a laser 1 and, as a rule, a first beam-forming optical system 2 for changing the diameter and for parallelizing a bundle of rays 3 emitted by laser 1 and a second beam-forming optical system 4 for focusing the bundle of rays 3 in an axial direction.

The machining chamber 13 has lead-through openings 7, through which a workpiece 8 that is to be machined is guided in the direction of its axis 11 (in the prior art referred to as principal axis).

The machining chamber 13 encloses a peripheral mirror 5 with peripheral mirror system axis 9. The workpiece axis 11 and the peripheral mirror system axis 9 are oriented parallel to each other or, preferably, coincide. The machining chamber 13 and the peripheral mirror 5 each have an identical beam entrance aperture 6, relative to which the optical system is disposed in such a manner that the bundle of rays 3, with the optical axis 15 perpendicular to the peripheral mirror system axis 9, is fed into the peripheral mirror 5 and, after multiple reflections from the peripheral mirror 5, impinges on the workpiece 8.

Depending on the geometry of the workpiece 8 and the machining objective, the system preferably has at least one moving mechanism that is able to generate a relative movement between the optical system, the peripheral mirror 5 and the workpiece 8.

Such a relative movement is necessary when the workpiece 8 is to be not only separated or machined along a specific length that corresponds to the width of the machining area 10, but also along longer lengths, or when the overall length of the workpiece is to be machined partially or completely along the periphery.

If the workpieces are extended workpieces, the workpiece 8 is preferably moved along the workpiece axis 11. A rotation about its own axis 11 can serve to influence the energy input across the periphery.

If workpieces 8 are involved that are individually, one after the other, introduced into the peripheral mirror 5 for machining, it may be useful to move the machining tool, i.e., the bundle of rays 3, which is of special advantage when the entire optical system, with or without the peripheral mirror 5, is moved in the direction of the workpiece axis 11. If the peripheral mirror 5 is not moved, the beam entrance aperture 6 must be an appropriately long slit so that the bundle of rays 3 can be fed in across the entire moving area. After completion of a workpiece 8, the optical system can be returned to its starting position or the next workpiece 8 to be machined can be machined by the return movement.

For example, when an extended workpiece 8 is to be merely separated, it is useful if there is at least one moving mechanism that is able, during machining, to move the optical system, the peripheral mirror 5 and the workpiece 8 jointly in the direction of the workpiece axis 11. This does not entail a relative movement, thus ensuring that even if the workpiece 8 is exposed for a relatively long time to the beam and if the rate of feed is high, the workpiece is machined along a length that equals the width of the machining area 10. After each machining procedure, the optical system and the peripheral mirror 5, if it is moved as well, are returned to their starting position.

Instead of using a moving mechanism for the optical system, it is also possible to use optically deflecting elements that are moved inside the optical system and that from time to time advance the optical axis 15 of the bundle of rays 3, which impinges on the peripheral mirror 5, following a given movement of the workpiece 8.

To carry out the method, a peripheral mirror 5 with a peripheral mirror system axis 9 is provided, into which mirror a workpiece 8 with a workpiece axis 11 is introduced in such a manner that the peripheral mirror system axis 9 and the workpiece axis 11 proceed in one direction.

Over a predefined machining time, a bundle of rays 3, proceeding along an optical axis 15 perpendicular to the peripheral mirror system axis 9, is fed into the peripheral mirror 5 and reflected multiple times from the mirror's reflecting surface until it impinges on the workpiece 8.

Suitable lasers 1 include all types of lasers that can be used to machine materials, such as CO₂ lasers, Nd:YAG lasers, in rod or plate configuration, fiber lasers or high-performance diode lasers, either as continuously emitting lasers, pulsed lasers or in oscillator/amplifier configurations. The laser parameters and process parameters are chosen and set depending on the properties of the material of the workpiece 8 and on the machining objective. In the context of the present invention, the radiation emitted by laser 1 is a bundle of rays 3 which is emitted by laser 1 throughout the machining time.

Depending on the radiation characteristics of laser 1, the first beam-forming optical system 2 is, e.g., a collimator, a telescope or a DEO [sic; DOE] (diffractive optical element), which is used to form, via the beam path, a quasi-paraxial bundle of rays 3, i.e. a bundle of rays 3 with minimum divergence at an energy density sufficiently high to achieve the machining objective, and to change, especially to expand, the diameter of the bundle of rays 3 in such a manner that it is large enough for the machining area 10 which is determined by the diameter of the bundle of rays 3 in the X-Y plane. If the laser 1 used already emits a beam at a sufficiently small angle of divergence, i.e., the deviation from paraxiality can be tolerated, this first beam-forming optical system 2 is not necessarily required.

The second beam-forming optical system 4 preferably is a cylindrical lens which focuses the bundle of rays 3 perpendicular to the cylinder axis which runs in the direction of the peripheral mirror system axis 9.

Using as a reference a Cartesian system of coordinates, through the point of coordinate origin of which the optical axis 15 proceeds, the bundle of rays 3 is focused in the X-Y plane so that a focusing line forms in the Y-Z plane.

In the direction of the cylinder axis, i.e., in the Y-Z plane, the bundle of rays 3 is unaffected and has a nearly constant width along the entire beam path, which width determines the width of the irradiated area (machining area 10). If a parallel bundle of rays 3 is fed into the peripheral mirror 5, this second beam-forming optical system 4 can be omitted.

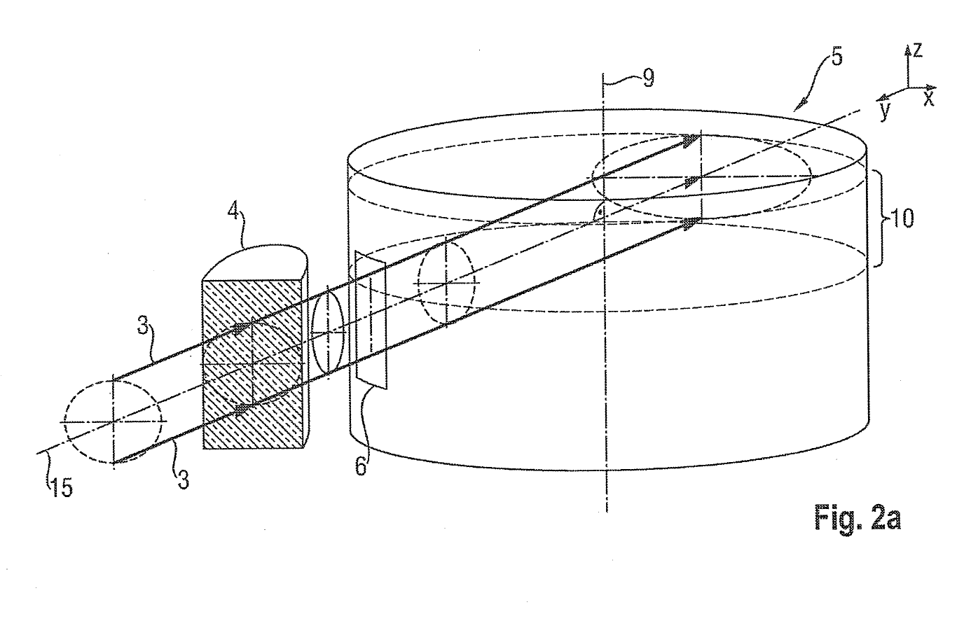

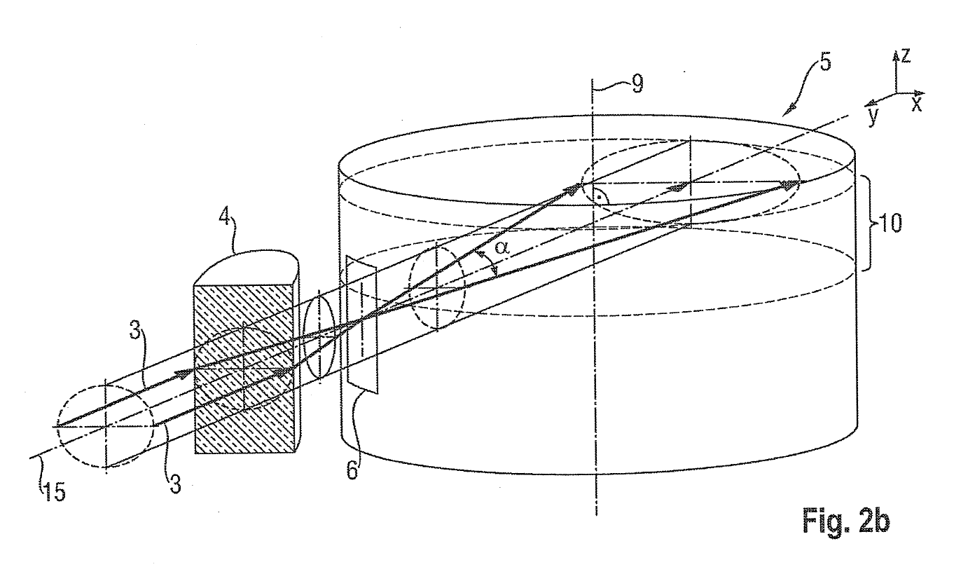

FIGS. 2a and 2b illustrate the path of the bundle of rays 3 in the aforementioned two main planes through the second beam-forming optical system 4, which is formed by a cylindrical lens, up to the first reflection in the peripheral mirror 5.

The optical configuration, formed by laser 1 and the two beam-forming optical systems 2, 4, is preferably dimensioned and disposed relative to the beam entrance aperture 6 in such a manner that the focusing line that forms in the bundle of rays 3 is located in the beam entrance aperture 6. As a result, this beam entrance aperture can be very narrow, which minimizes the risk that portions of a bundle of rays 3 that has been fed into the peripheral mirror 5 are able to exit. The beam entrance aperture 6 can be a true opening in the machining chamber 13 or in the peripheral mirror 5 or it can be an area in which the machining chamber 13 and the peripheral mirror 5 are transparent to the bundle of rays 3 of laser 1. In the embodiment that is most useful for practical applications, the beam entrance aperture 6 in the machining chamber 13 is a window, and in the peripheral mirror 5, the beam entrance aperture 6 is a true opening.

The peripheral mirror 5 is formed by the inside surface of a cylindrical, rectangular or prismatic hollow body or, in special embodiments, of a hollow truncated cone or a hollow truncated pyramid. The inside surface can form a reflecting surface that is composed of a plurality of subsurfaces, the number, geometry and configuration of which relative to one another determine the different potential cross sections of the peripheral mirror 5, as will be explained in greater detail in the following practical examples.

Only the reflecting surface determines the function of the peripheral mirror 5, i.e., if the peripheral mirror 5, as shown in FIG. 1, is surrounded by a machining chamber 13, this chamber serves only to hold the peripheral mirror 5 and to contain the fed-in bundle of rays 3. Thus, the containment is a safety measure and not necessarily required for the functioning of the system.

It is useful for the peripheral mirror 5 to have different suitable cross sections depending on the cross section of the workpiece 8 and on the machining objective.

Cross sections suitable for the peripheral mirror 5 include, in particular, circles, ovals and polygons formed by subsurfaces with—for manufacturing reasons—preferably identical edge lengths and identical internal angles.

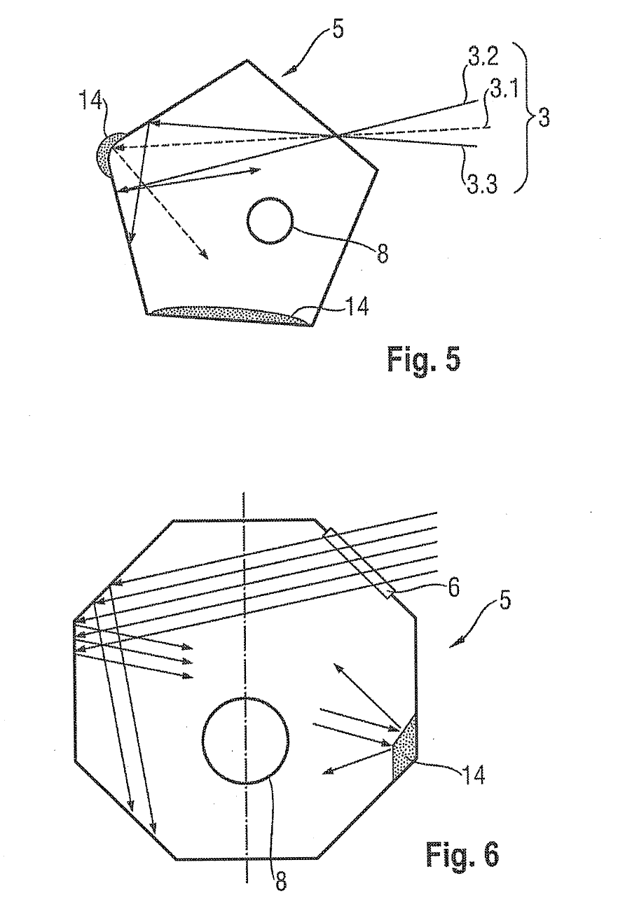

Additional mirror elements 14, as shown in FIGS. 5 and 6, which are freely disposed in or attached to the inside of the peripheral mirror 5, can enhance the targeted guidance of the bundle of rays 3.

The objective is to guide the bundle of rays 3, which is fed into the peripheral mirror for a limited time, by reflection inside the peripheral mirror 5 in such a manner that it ultimately impinges on the periphery of the workpiece 8 and that its radiation energy at the site of impingement is absorbed. Once the bundle of rays 3 impinges on the workpiece 8, the bundle of rays 3, emitting from laser 1, has traveled its distance. At the site of absorption, the material is affected. If material is to be removed, the path of the bundle of rays 3 is allowed to pass so that subsequently following radiation energy is directed past the workpiece 8 and, after a second reflection of the bundle of ray 3 from the peripheral mirror 5, impinges on a different area on the periphery of the workpiece 8.

Ideally, the peripheral mirror 5 and any optional additional mirror elements 14 are geared to the geometry of the periphery and the dimension of the workpiece 8 to ensure that, within the machining area 10, the peripheral surface, or a peripheral subsurface of the workpiece 8 if only this subsurface is to be machined, is uniformly exposed to radiation energy.

A system according to the present invention is especially useful when the periphery of cylindrical, wire-shaped, strip-shaped or tubular workpieces 8, in particular long or so-called endless extended workpieces, are to be machined. The endless extended workpieces are passed through the peripheral mirror 5 in the direction of its peripheral mirror system axis 9 in order to be machined along their total length or only in segments along their length. Since the peripheral mirror 5, in the direction of the peripheral mirror system axis 9, is freely accessible from both sides, it is easy for the workpiece 8 to enter, pass through, and exit the mirror, i.e., any handling devices required have free access to the mirror. In this context, long extended workpieces are defined to also include individual parts, such as screws, bolts and tubular sections.

Another advantage is that simply by replacing the peripheral mirror 5 or the machining chamber 13 with the peripheral mirror 5, the system can be adapted to workpieces 8 having a different cross-sectional geometry or different dimensions, or to a different machining objective.

The person skilled in the art is aware of the fact that the machining chamber 13 can be connected to a suction device by means of which the material removed by the laser beam can be discharged. It is also possible to include a cooling device for cooling the peripheral mirror 5.

As a rule, the workpiece axis 11 is disposed in the peripheral mirror system axis 9; however, in special practical examples, it can also be disposed parallel thereto.

In all cases, however, the workpiece axis 11 and the peripheral mirror system axis 9 are oriented in the same direction.

The workpieces 8, instead of being extended solid workpieces, can be, in particular, extended viscous fluid workpieces, in which case non-contact machining in the manner disclosed by the present invention is of very special advantage.

In the context of the present invention, the terms machining and machining objective are defined as any conceivable method of influencing a material by exposing it to laser radiation, e.g., heating, evaporation and sublimation, removal, exposure to radiation with the objective of modifying the surface, coating, constriction or separation of the extended workpiece. When selecting a peripheral mirror 5 with suitable geometry and dimensions, consideration must be given to whether the workpiece 8 is to be completely cut through, in which case the machining area 10 should be as narrow as possible, or whether an areal surface across a peripheral region of the workpiece 8 is to be removed or thermally influenced, in which case the machining area 10 should have a predeteimined width or should be a wide as possible.

Within a machining area 10, it is possible to machine the entire periphery or only a partial region of the periphery of the workpiece 8, e.g., by heating only the lower surface of strip steel.

The workpieces 8 can be made of any material that can be machined by means of a laser, e.g., glass, polymers and metals, and melts thereof.

During machining, the workpiece 8, in particular an extended workpiece, can be moved relative to the peripheral mirror 5 in the direction of its axis 11 and/or can be rotated about its axis 11 or remain stationary. To ensure that the workpiece 8 can be moved at a constant speed, it is recommended, especially to increase the local energy input, that a moving mechanism be provided, by means of which the optical system tracks the workpiece 8 during machining.

Whether a relative movement is executed, what type of relative movement is involved, and at what speed the potential relative movement takes place depends on the machining objective.

Instead of only one optical system, the overall system can also comprise two or more optical systems, each of which has its own lasers 1 which emit bundles of rays 3 of different wavelengths.

Simultaneous or chronologically consecutive machining with bundles of rays 3 of different wavelengths can be of advantage, e.g., if the workpieces 8 that are being machined are made of a semitransparent material that absorbs different wavelengths at different machining depths. For example, each of the two optical systems can have a beam entrance aperture 6, thereby making it possible to overlap the machining areas 10, or the bundles of rays 3, which at the feed-in level are offset relative to each other, can be fed in through a shared beam entrance aperture 6 that is expanded, as needed, in the direction of the peripheral mirror system axis 9, thus allowing chronologically consecutive machining.

Below, a few practical examples will be described that differ from one another especially in that the design of the peripheral mirror 5 differs.

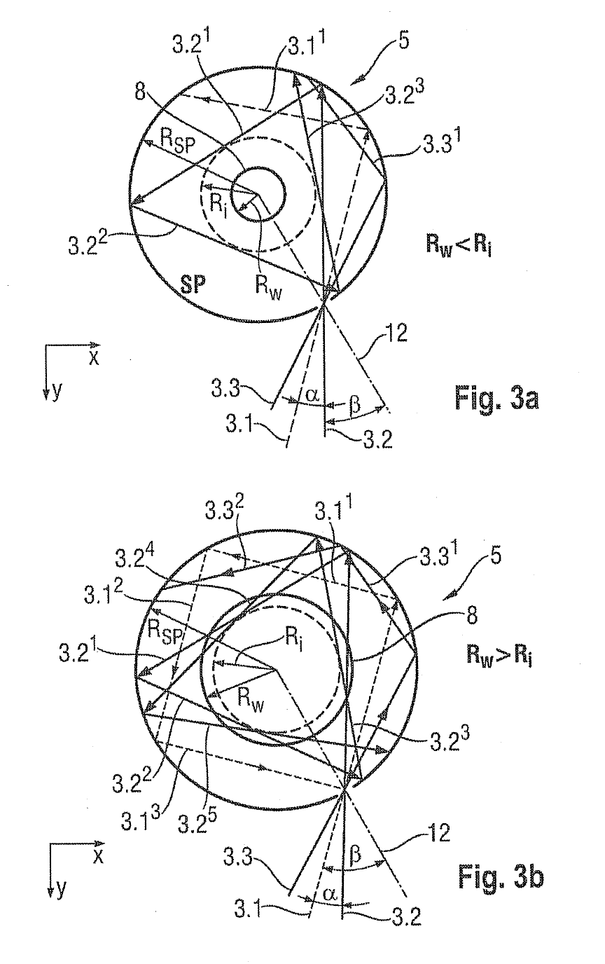

In a first practical example which is explained based on FIGS. 3a and 3b, the peripheral mirror 5 is formed by a circular cylindrical mirror with a reflecting surface that is defined by a circle with the radius of curvature R_{SP}. The drawing plane is the X-Y plane in which the bundle of rays 3, as a divergent bundle of rays, spreads out as a result of multiple reflections on the reflecting surface with the radius of curvature R_{SP}.

Of the bundle of rays 3 that impinge on the peripheral mirror 5, an axial ray 3.1 appears as a thin dashed line, a first marginal ray 3.2 as a bold solid line and the second marginal ray 3.3 as a bold dashed line.

All rays of the bundle of rays 3 intersect in the focusing line which is located in the beam entrance aperture 6, with the marginal lines 3.2, 3.3 and the axial ray 3.1 forming a semiaperture angle α which determines the divergence of the bundle of rays 3, and with the axial ray 3.1 and a surface normal 12 of the reflecting surface, which proceeds through the focusing line, forming an angle of inclination 13 which determines the direction of incidence of the bundle of rays 3 into the peripheral mirror 5.

As a comparison of FIG. 3a with FIG. 3b clearly demonstrates, the multiply reflected marginal ray 3.2, given the same parameters α, β and R_{SP}, invariably runs tangentially to a central area with the boundary radius Rᵢ. All other rays of the bundle of rays 3 (in the figures, only the first marginal ray 3.2 and the second marginal ray 3.3 are shown) proceed at a greater distance from this central area. As illustrated in FIG. 3a, a work piece 8 with a radius R_{W} smaller than Rᵢ is not exposed to a bundle of rays 3, and therefore, no machining takes place, while a workpiece 8 with a radius R_{W} larger than Rᵢ can be targetedly machined across its periphery, starting at the periphery of the workpiece and penetrating the surface down to a predetermined depth.

The first practical example of a peripheral mirror 5 can be used to excellent advantage, e.g., for removing or hardening surface layers, in particular rotationally symmetric extended workpieces, when the workpiece 8 is to be machined only down to a predetermined depth.

By selecting the parameters α, β, and the width of the bundle of rays 3 in the Y-Z plane, the width of the machining area 10 across the periphery of the workpiece 8 and the depth down to which workpiece 8 is exposed to radiation energy from the bundle of ray 3 that impinges on the periphery are determined.

The depth results from the difference between the workpiece radius R_{w} and the boundary radius Rᵢ that forms as a result of the beam parameters selected, thus making it possible, e.g., to produce a groove of predetermined depth and width on the workpiece 8.

By manipulating the semiaperture angle α and the angle of inclination B in such a manner that the boundary radius Rᵢ at the beginning of machining equals the workpiece radius R_{W} and reaches zero after a predetermined length of time, the workpiece 8 is targetedly and reproducibly exposed to the radiation energy. If the material of the workpiece 8 is semitransparent to the laser wavelength of the bundle of rays 3, the radiation energy can penetrate into the workpiece 8.

Viscous materials, the viscosity of which is highly dependent on the temperature, e.g., a glass mass, in particular, simultaneously undergo heating, a decrease in the viscosity, evaporation, constriction as a result of the surface tension and separation and/or droplet formation caused by the gravitational force or other external forces.

During machining, the workpiece 8 can be in a stationary resting position relative to the peripheral mirror 5—and thus to the spreading bundle of rays 3—or the workpiece can be moved along its axis 11, which, in correlation with the axial speed, leads to an areal irradiation across a width greater than the machining area 10.

During machining, the entire machining area 10 remains exposed to radiation, and the periphery of the workpiece 8 is irradiated and machined uniformly and nearly simultaneously.

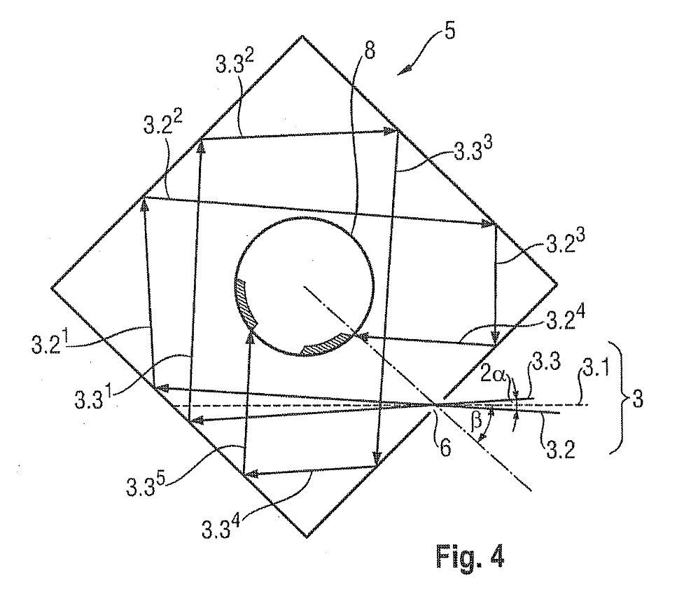

In a second practical example, which is explained based on FIG. 4, the peripheral mirror 5 is formed by a mirror having a square cross section, i.e., the reflecting surface comprises four plane subsurfaces that form right-angle corners.

Starting from the beam entrance aperture 6 in which the focusing line of a bundle of rays 3 is located, the figure shows an axial ray 3.1 and the marginal rays 3.2 and 3.3 of the bundle of rays 3, segments of which, in accordance with the preceding reflections, have an exponent.

Thus, the path of the beam inside the peripheral mirror 5 can be readily followed and shows, e.g., a first impingement of the bundle of rays 3 through the marginal ray 3.2⁴ on the workpiece 8 after the fourth reflection.

In contrast to the first practical example of a peripheral mirror 5, this solution is useful if, during machining, the workpiece 8 is rotated about is axis 11, which has the effect that the material is machined uniformly across the periphery.

Uniform machining can be further enhanced by the adjustment of the number of subsurfaces and a reflection in the corners between the subsurfaces, which causes beam division.

FIG. 5 shows a third practical example of a peripheral mirror 5 that is formed by a mirror having a pentagonal cross section.

A bundle of rays 3 that forms, as in the preceding practical examples, a focusing line in the beam entrance aperture 6 diverges in the drawing plane that constitutes the X-Y plane. The bundle of rays 3, represented by the three rays 3.1, 3.2 and 3.3, is fed into the peripheral mirror 5 in such a manner that it impinges on a concavely configured corner between two neighboring subsurfaces, as a result of which the bundle of rays 3 spreads out considerably, and after additional reflections, the rays, subsequently coming from different directions, impinge on the workpiece 8.

Like the corners, the subsurface can be spherical or aspherical instead of plane.

The shape of the reflecting surface can be changed either by changing the subsurfaces or the corners of the mirror or by stationarily attaching additional mirror elements 14 to the peripheral mirror 5, as shown in FIGS. 5 and 6.

As FIG. 5 illustrates, the workpiece 8 with its workpiece axis 11 can also be disposed parallel to the peripheral mirror system axis 9.

In the fourth practical example, the peripheral mirror 5 shown in FIG. 6 is formed by a mirror having an octagonal cross section.

In this example, the incident bundle of rays 3, represented by five rays, first impinges on a corner which causes the rays to divide. It shows an additional mirror element 14, which causes the rays to divide as well, but which also changes the rotational direction of the resultant subbundle of rays.

In contrast to the practical examples described above, instead of a divergent bundle of rays 3, a bundle of rays 3 that is also quasi-paraxial in the X-Y plane is fed into the peripheral mirror 5.

In the previously described practical examples, the bundle of rays 3 is fed into the peripheral mirror 5 in such a manner that the optical axis 15 does not intersect the peripheral mirror system axis 9 by having it proceed out-of-square to the axis peripheral mirror system axis 9.

However, as described in the two following practical examples, the bundle of rays 3 can also be fed into, and deflected in, the peripheral mirror in such a manner that the optical axis 15 does not coincide with the peripheral mirror system axis 9 since an additional mirror element 14 is disposed inside the peripheral mirror 5 so that a first reflection from this minor element takes place.

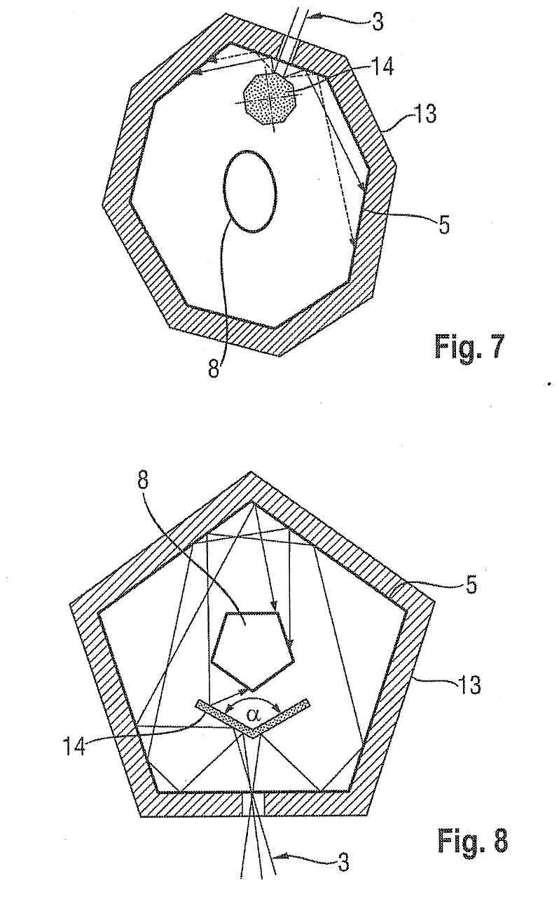

In the fifth practical example shown in FIG. 7, a bundle of rays 3 that is again quasi-paraxial in the X-Y plane is to be fed into the peripheral mirror 5 which again has an octagonal cross section, except that the subsurfaces have edges of different lengths.

An additional mirror element 14, here a rotating polygonal mirror, ensures that the bundle of rays 3 (in the figure represented by two boundary rays) is divided into two subbundles of rays and that these impinge at a continuously changing deflection angle on different first subsurfaces of the peripheral mirror 5. Thus, in contrast to all previous practical examples, the path of the bundle of rays 3 continuously changes over time until the bundle of rays impinges on the workpiece 8 (which in this example has an elliptical cross section) at continuously changing points.

FIG. 8 shows a sixth practical example in which an additional mirror element 14, here a corner minor, is again disposed inside the peripheral mirror 5.

Again, a first division of the bundle of rays 3 into subbundles of rays takes place before they impinge for the first time on a subsurface of the peripheral mirror 5, i.e., prior to a first reflection from the peripheral mirror 5. The subbundles of rays spread mirror-symmetrically in the opposite direction around the workpiece 8 and impinge via multiple reflections on the workpiece 8. In this example, the workpiece 8 has a pentagonal cross section with identical edge lengths.

All practical examples described above have in common that the radiation energy emitted by a source of radiation, in particular a laser 1, is applied for a predetermined time to the entire periphery of a workpiece 8 by the incident bundles of rays 3.

A system according to the present invention, however, is not limited to only one source of radiation, just as it is not limited to a peripheral mirror 5 with surface normals 12 perpendicular to the peripheral minor system axis 9, which will be demonstrated in a seventh and eighth practical example.

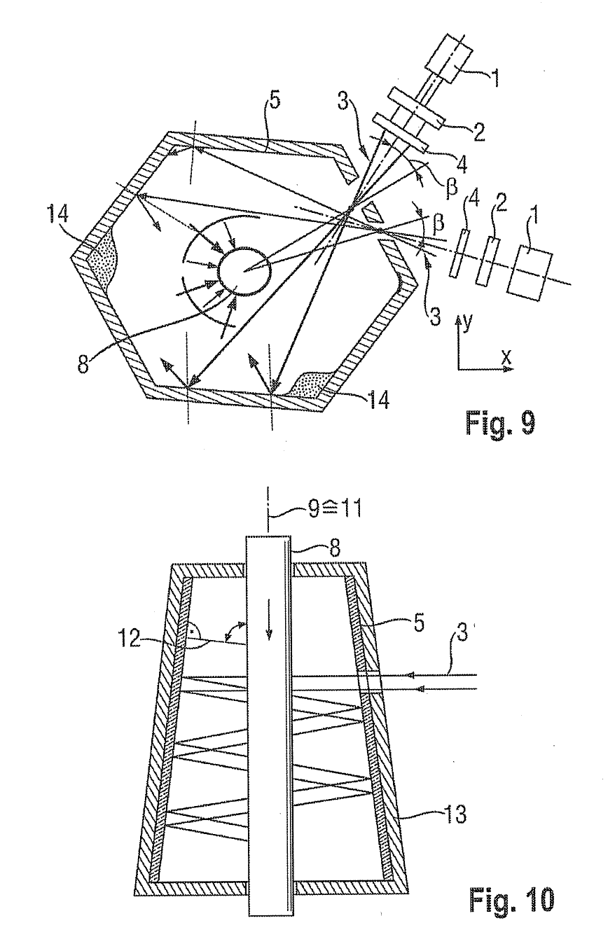

A seventh practical example, which is illustrated in FIG. 9, comprises two lasers 1 with upstream beam-forming optical systems 2, 4 and one beam entrance aperture 6 each. This allows two bundles of rays 3 to be fed, preferably simultaneously, into the peripheral mirror 5. These bundles can have an identical beam geometry and be fed into the peripheral mirror 5 under an identical angle of inclination B, thus doubling the input of radiation energy into the workpiece 8.

However, the beam-forming optical systems 2, 4 can also be configured in a different manner so that, e.g., the width of the two bundles of rays 3 across the Y-Z plane differs, e.g., when the workpiece 8 is to be hardened by means of radiation across a predetermined machining area 10 and, at the same time, separated within a considerably smaller machining area 10.

The two bundles of rays 3 can also be fed at different heights into the peripheral mirror 5 in order to machine the periphery of the workpiece 8, e.g., a first time as they pass an upper machining area 10 and a second time as they pass a lower machining area 10.

The practical example illustrated also shows additional mirror elements 14 that are attached to the peripheral mirror 5.

One of the two additional mirror elements 14 has a convexly curved reflecting surface, which increases the divergence of the incident bundle of rays 3, while the second additional mirror element 14 comprises two plane subsurfaces that form an obtuse angle with each other so that the bundle of rays 3 is divided into two subbundles of rays while the divergence angle is maintained.

The additional mirror elements 14 adjoin the reflecting surface of the peripheral mirror 5 via concave transition areas, which has a positive effect on the reflection.

An eighth practical example, which is shown in FIG. 10, differs from the preceding practical examples in which the surface normals 12 of the peripheral mirror 5 at each point of the reflecting surface are located perpendicular to the peripheral mirror system axis 9, in that the surface normals 12 form an identical angle smaller than 90° with the peripheral mirror system axis 9. The peripheral mirror 5 can, e.g., have the form of a truncated pyramid or a truncated cone.

Depending on the angle, the bundle of rays 3 is deflected in the direction of the peripheral mirror system axis 9 and thus in the direction of the workpiece axis 11. This enlarges the machining area 10.

This solution also has the advantage that a bundle of rays 3 is definitely not multiply reflected from the same areas of the peripheral mirror 5, which means that the thermal stress on the peripheral mirror 5 is lower.

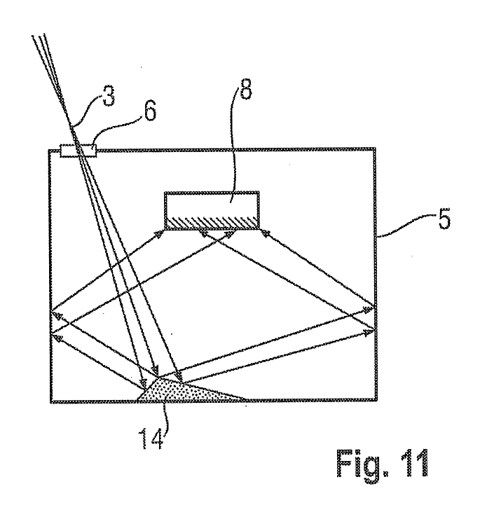

The intent of the ninth practical example, which is shown in FIG. 11, is to illustrate that it is also possible to only partially machine the periphery of a workpiece 8. The beam parameter of the bundle of rays 3 and the cross section of the peripheral mirror 5 and its dimension, in combination with an additional mirror element 14, were chosen to ensure that the bundle of rays 3, after beam division and double reflection, impinges completely on one side of the workpiece 8, which in this case is a strip-shaped extended workpiece.

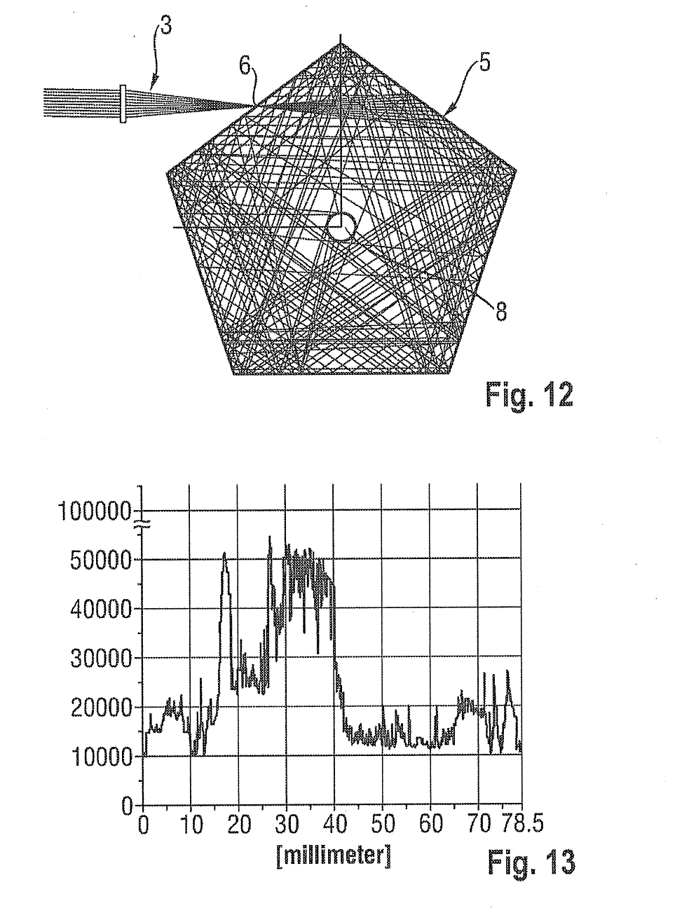

A tenth practical example will be explained with reference to FIG. 12 and FIG. 13.

The resultant energy distribution on the periphery of a workpiece 8 with ten thousand rays at a threshold value of 5% was calculated for a peripheral mirror 5 formed by a cylindrical mirror having a pentagonal cross section, with edge lengths of 72.75 mm and a reflectance of 99.8%.

FIG. 12 illustrates the path of the rays, but for the sake of visual clarity, only ten rays of the bundle of rays 3 are shown.

The diagram in FIG. 13 shows the number of the incident rays of the bundle of rays 3 that are equivalent to a distribution of the radiation energy which, distributed across the periphery of the workpiece 8, was introduced by the impingement of the bundles of rays 3 on the workpiece.

The workpiece 8 is an extended workpiece with a degree of absorption of 99.8% and a diameter of 25 mm, from which the periphery of the workpiece 8 is calculated as approximately 78.5 mm.

A bundle of rays 3 fed into the peripheral mirror 5 has a semiaperture angle α of 6.4° and is bundled in a focusing line in the beam entrance aperture 6.

The waveform shows peripheral sections, e.g., in the range of 43-65 mm, in which the waveform remains within a relatively narrow tolerance range. However, the waveform also shows peripheral sections with large deflections, which does not lead to the desired uniform peripheral machining results.

Even just one beam division before the first reflection in the peripheral mirror 5 would lead to an overlap with the mirror-inverted curve at half the number of rays and thus to a markedly more uniform incidence of energy on the workpiece 8.

If the machining objective is to completely cut through the workpiece 8, the distribution shown here may suffice. However, a defined removal of material across the periphery requires measures by means of which the path of the rays is influenced in such a manner that the distribution curve across the entire peripheral region remains within a reasonable tolerance range.

A more uniform distribution can be obtained by widening the distance between the workpiece 8 and the peripheral mirror 5 and by instituting the measures for forming and dividing the bundle of rays 3 which were extensively described in the practical examples.

Ensuring uniformity may also be achieved in a simple manner by rotating the workpiece 8 about its axis 11 during machining.

As already explained, during machining, the workpiece 8 and the machining system can be maintained in a stationary resting position relative to each other or they can be moved relative to each other. In the stationary resting position relative to each other, the workpiece 8 which is passed at a constant speed through the machining chamber 13 can be stopped for the period during which it is being machined or, preferably, the optical system can track the workpiece 8. Thus, the length of exposure to the laser radiation can be increased.

All practical examples described above show that, especially depending on the cross section of the workpiece 8 and the machining objective, it is possible to carry out the method and configure the system in different ways. The person skilled in the art has been given many suggestions and options to choose from so as to obtain an optimum result.

### LIST OF REFERENCE SYMBOLS

1 Laser
2 First beam-forming optical system
3 Bundle of rays
3.1-3.n Main rays of the bundle of rays
2.1^{m}-3.n^{m} Main rays of the bundle of rays after m^{th} reflection
4 Second beam-forming optical system
5 Peripheral mirror
6 Beam entrance aperture
7 Lead-through opening
8 Workpiece
9 Peripheral mirror system axis
10 Machining area
11 Workpiece axis
12 Surface normal
13 Machining chamber
14 Additional mirror element
15 Optical axis
α Semiaperture angle
β Angle of inclination
R_{SP} Radius of curvature
Rᵢ Boundary radius
R_{W} Workpiece radius

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A system for machining the periphery of a workpiece, comprising an optical system having an optical axis and an associated laser that emits a bundle of rays along the optical axis, and a peripheral mirror having a peripheral mirror system axis, the mirror being disposed around the workpiece, which is to be machined and which has a workpiece axis so that the peripheral mirror axis and the workpiece axis are oriented in the same direction, the said peripheral mirror, on its periphery, having a beam entrance aperture relative to which the optical system is disposed so that the bundle of rays, with the optical axis perpendicular to the peripheral mirror system axis, is fed into the peripheral mirror and, after multiple reflections from the peripheral mirror, impinges the workpiece.

2. The system as in claim 1, wherein said peripheral mirror is enclosed by a machining chamber that also has a beam entrance aperture and two lead-through openings through which the workpiece to be machined is passed in the direction of its workpiece axis through the machining chamber.

3. The system as in claim 1, wherein said optical system comprises a first beam-forming optical system for changing the diameter and for parallelizing the bundle of rays that is emitted by the laser.

4. The system as in claim 3, wherein said optical system comprises a second beam-forming optical system for focusing the bundle of rays in the X-Y plan, which is a plane perpendicular to the Y-Z plane that is defined by the optical axis and the peripheral mirror system axis.

5. The system as in claim 4, wherein said second beam-forming optical system is configured in such a manner that a focusing line that forms is located in a beam entrance aperture.

6. The system as in claim 1, wherein said peripheral mirror has the form of a hollow body, the inside surface of which forms a reflecting surface.

7. The system as in claim 6, wherein the surface normals, at each point of said reflecting surface are perpendicular to the peripheral mirror system axis.

8. The system as in claim 6, wherein said surface normals, at each point of the reflecting surface form an angle smaller than 90° with the peripheral mirror system axis.

9. The system as in claim 6, wherein said reflecting surface is composed of a plurality of subsurfaces that form corners with one another and the number, geometry and configuration relative to one another determines the cross section of the peripheral mirror.

10. The system as in claim 6, wherein said reflecting surface is a circular cylindrical surface.

11. The system as in claim 9, wherein said subsurfaces form polygons having identical edge lengths and identical internal angles.

12. The system as in claim 1, further comprising an additional mirror element disposed inside the peripheral mirror.

13. The system as in claim 12, wherein said additional mirror element is a rotating polygonal mirror.

14. The system as in claim 1, further comprising an additional mirror element disposed on the peripheral mirror.

15. The system as in claim 1, wherein said workpiece axis is disposed in the peripheral mirror system axis.

16. The system as in claim 9, characterized in that at least one corner or one subsurface is configured in the form of a spherical or aspherical surface.

17. The system as in claim 1, further comprising an additional beam entrance opening and a second optical system are provided so as to be able to feed two bundles of rays into the peripheral mirror.

18. The system as in claim 17, wherein said second optical system comprises a laser that emits a bundle of rays at a wavelength different from that of the laser of the first optical system.

19. The system as in claim 1, further comprising a moving mechanism capable of generating relative movement between the optical system, the peripheral mirror, and the workpiece.

20. The system as in claim 1, further comprising an available moving mechanism capable of moving said optical system, the peripheral mirror, and the workpiece jointly in the direction of the workpiece axis.

21. A method of machining the periphery of a workpiece by means of a laser wherein a peripheral mirror with a peripheral mirror system axis is used and a workpiece with a workpiece axis introduced into the peripheral mirror such a manner that the peripheral mirror system axis and the workpiece axis proceed in one direction, comprising emitting a bundle of rays from said laser along an optical axis perpendicular to the peripheral mirror system axis; feeding said bundle into the peripheral mirror, said rays being multiply reflected from the reflecting surface of said peripheral mirror until it impinges on the workpiece.

22. The method as in claim 21, wherein said bundle of rays, prior to entering the peripheral mirror, is parallelized.

23. The method as in claim 21, wherein said bundle of rays, prior to entering the peripheral mirror, is focused in the direction perpendicular to the peripheral mirror system axis.

24. The method as in claim 21, further comprising moving said workpiece along its axis relative to the peripheral mirror system axis and/or rotating said workpiece about its axis during machining time.

25. The method as in claim 21, further comprising moving said optical system in the direction of the workpiece axis during machining time.

26. The method as in claim 21, further comprising moving said optical system and said peripheral mirror in the direction of the workpiece axis during machining time.

27. The method as in claim 21, further comprising moving said optical system, said peripheral mirror and said workpiece in the direction of the workpiece axis during machining time.

28. The method as in claim 21, further comprising dividing said bundle of rays into two subbundles of rays prior to a first reflection.

29. The method as in claim 21, wherein more than one bundle of rays is fed into the peripheral mirror.

30. The method as in claim 29, wherein said more than one bundles of rays have different wavelengths.
